(19) United States
(12) Patent Application Publication
(10) Pub. No.: US 2003/0085913 A1
(43) Pub. Date: May 8, 2003

(54) Creation of slideshow based on characteristic of audio content used to produce accompanying audio display

(75) Inventors: Subutai Ahmad, Palo Alto, CA (US); Sai-Wai Fu, Los Altos Hills, CA (US); Jonathan R. Cohen, San Francisco, CA (US)

Correspondence Address: David R. Graham, 1337 Chewpon Avenue, Milpitas, CA, 95035, US

(73) Assignee: YesVideo, Inc.

(21) Appl. No.: 10/226,668

(22) Filed: Aug. 21, 2002

Related U.S. Application Data
(60) Provisional application No. 60/314,229, filed on Aug. 21, 2001.

(51) Int. Cl. G09G 5/00

(52) U.S. Cl. 345/730

(57) ABSTRACT

The invention enables creation of a slideshow that is to be accompanied by an audio content display. In particular, the invention makes use of the audio content to create the slideshow.

### BACKGROUND OF THE INVENTION

1. Field of the Invention

This invention relates to the display of a series of visual images and, in particular, to the display of a series of visual images with an accompanying audio display.

2. Related Art

There are a large number of products aimed at helping consumers interact with (e.g., view, digitize, edit, organize, share) their home video (or other multimedia content) using a personal computer (e.g., desktop computer, laptop computer). Those computer-based products are typically very labor intensive and require a significant amount of time to manipulate the video into the desired final form.

An increasing number of consumers want to interact with their home video (or other multimedia content) using a television-based platform (e.g., television or home theater system). Very little technology has been developed to enable consumer interaction with home video using a television-based platform. Current approaches to enabling interaction with home videos on a television-based platform are primarily restricted to tape-based playback mechanisms. These approaches are highly restricted because: 1) tape is a linear playback mechanism, 2) tape is slow to rewind and fast forward, 3) tape quality degrades rapidly with usage and time, and 4) it is very difficult to extract still visual images from tape. The advent of digital media has opened up new possibilities for interacting with home video.

Additionally, user input devices (e.g., television remote control devices) used with television-based platforms are very different from those used with computers (e.g., keyboards, mice). In particular, the remote control devices used with television-based systems typically afford a more limited range of user input than that enabled by a keyboard and mouse commonly used with a computer. Thus, a difficulty in developing technology for interacting with home video using a television-based platform is that the user input required for effecting such interaction should be kept relatively simple.

It can be desirable to display individual visual images (e.g., individual visual images extracted from a home video) and display those images in a series (herein, such a series of visual images is referred to as a “slideshow”). A slideshow can be accompanied by an audio display. Individual visual images can be selected manually for display (i.e., the order of display of the visual images and duration of display of each visual image) with the audio based on the content of the audio. However, such a process can be difficult and time consuming and may not produce the desired effect. It would be desirable to automatically create a slideshow in which the display of the visual images is based on the content of the audio.

### SUMMARY OF THE INVENTION

The invention enables creation of a slideshow that is to be accompanied by an audio content display. In particular, the invention makes use of the audio content to create the slideshow.

In one embodiment of the invention, creation of a slideshow that is to be accompanied by display of a set of audio content (e.g., music) is accomplished by ascertaining one or more characteristics of the set of audio content, then determining the duration of the display of each of a series of visual images to be displayed as part of the slideshow (the slideshow images), based on the audio content characteristic(s). This embodiment of the invention can further be implemented so that the audio content is evaluated to identify the audio content characteristic(s). For example, when the audio content is music, the music can be evaluated to identify the beats in the music. This embodiment of the invention can further be implemented so that the determination of the duration of the display of each of the slideshow images is further based on one or more characteristics of the slideshow images. In addition to determining the duration of the display of each of the slideshow images, this embodiment of the invention can be implemented to select the slideshow images from a collection of visual images (e.g., a collection of still images or a visual recording). The selection of slideshow images can be based on one or more characteristics of the collection of visual images and this embodiment of the invention can be implemented to evaluate the collection of visual images to identify those characteristic(s). For example, the quality of each of the visual images in the collection of visual images can be evaluated and/or keyframes can be identified in the collection of visual images. Additionally, the selection of slideshow images can be based on the duration of the slideshow (the duration of the slideshow can be established, for example, as the duration of a single display of the set of audio content or two or more repetitions of the display of the set of audio content). For example, the duration of the slideshow and the duration of the display of each slideshow image will often limit the number of visual images that are included in a slideshow from a collection of visual images. This embodiment of the invention can further be implemented to specify an order of display of the slideshow images. For example, the slideshow images can be displayed in chronological order and/or the slideshow images can be displayed in an order based on a determination of the quality of the slideshow images (e.g., the slideshow images are displayed in order of decreasing quality). In a method according to this embodiment of the invention, at least one of the steps of the method is performed automatically (e.g., ascertaining audio content characteristic(s), ascertaining visual image characteristic(s), ascertaining the duration of the slideshow, determining the duration of display of each slideshow image, selecting the slideshow images, specifying the order of display of slideshow images).

In another embodiment of the invention, creation of a slideshow that is to be accompanied by display of a set of audio content (e.g., music) is accomplished by identifying audio units in the set of audio content (e.g., identifying beats in music), specifying a number of visual images to be displayed for each audio unit, and identifying a visual image or images corresponding to each audio unit. The identification of audio units (e.g., beats in music) can be done manually or automatically.

### BRIEF DESCRIPTION OF THE DRAWINGS

FIG. 1 is a block diagram illustrating components of a system in which the invention can be used.

FIG. 2 is a flow chart of a method, according to an embodiment of the invention, for creating a slideshow that is to be accompanied by display of a set of audio content.

FIG. 3 is a flow chart of a method, according to another embodiment of the invention, for creating a slideshow that is to be accompanied by display of a set of audio content.

FIG. 4 is a flow chart of a method, according to yet another embodiment of the invention, for creating a slideshow that is to be accompanied by display of a set of audio content.

FIG. 5 is a flow chart of a method, according to still another embodiment of the invention, for creating a slideshow that is to be accompanied by display of a set of audio content.

FIG. 6 is a flow chart of a method, according to another embodiment of the invention, for creating a slideshow that is to be accompanied by display of a set of audio content.

FIG. 7 is a flow chart of a method, according to another embodiment of the invention, for creating a slideshow that is to be accompanied by display of a set of audio content.

### DETAILED DESCRIPTION OF THE INVENTION

The invention enables creation of a slideshow that is to be accompanied by an audio content display. (Herein, “slideshow” refers to a series of visual images other than a series of visual images constituting a visual recording. A “visual recording” is a series of visual images acquired at a regular interval by a visual data acquisition apparatus such as a video camera and representing visual content that occurs over a period of time.) In particular, the invention makes use of the audio content to create the slideshow. The invention can be implemented so that the duration of the display of each visual image in the slideshow is based on one or more characteristics of the audio content (e.g., the occurrence of beats in music). The invention can be further implemented so that the duration of the display of the visual images in the slideshow is based on one or more characteristics of the visual images. The invention can also be implemented so that the visual images of the slideshow are selected from a collection of visual images (e.g., a collection of still images or a visual recording). The selection of visual images for use in a slideshow can be based on one or more characteristics of the collection of visual images. For example, the selection of visual images for use in a slideshow can be based on the quality of each of the visual images in the collection of visual images and/or the identification of keyframes in the collection of visual images. The selection of visual images for use in a slideshow can also be based on the duration of the slideshow (which can he equal to the duration of a single display of the audio content or multiple displays of the audio content). The visual images can be displayed in any order and, in particular, an order that is different from that in which the visual images are originally arranged (such as chronological order).

The invention can be used to enhance a home theater system (or other audiovisual display system) to, for example, make viewing of home video easier and more enjoyable. As described further below, the invention can be advantageously used to enable creation of a slideshow from a visual recording (e.g., videotape) and provision of a musical overlay to accompany the slideshow. An advantage of the invention is that the invention can be automated to enable a slideshow to be created easily and rapidly. In particular, at least some part of the creation of a slideshow according to the invention is performed automatically (e.g, ascertaining audio content characteristic(s), ascertaining visual image characteristic(s), ascertaining the duration of the slideshow, determining the duration of display of each slideshow image, selecting the slideshow images, specifying the order of display of slideshow images). The invention can be implemented, for example, with an audiovisual display system (e.g., television, home theater system) to enable creation of a slideshow using a simple remote control and a small number of inputs (e.g., button clicks) to the remote control. Thus, the invention has particular utility in enabling non-professionals to create a slideshow accompanied by an audio display, since such users may lack the sophistication, desire or time to otherwise create the slideshow.

The invention makes use of two types of data to enable creation of a slideshow: content data (e.g., visual recording data, still visual image data, audio data) and metadata. Herein, “metadata” is used as known in the art to refer to data that represents information about the content data. Examples of metadata are described in more detail below. Metadata can be created manually (e.g., specification by the creator of a set of content data of a title for, or a description of, the set of content data). Metadata can also be extracted automatically from a set of content data (e.g., automatic evaluation of the quality of a visual image, automatic determination of scene breaks and/or keyframes in a visual recording, automatic identification of beats in music).

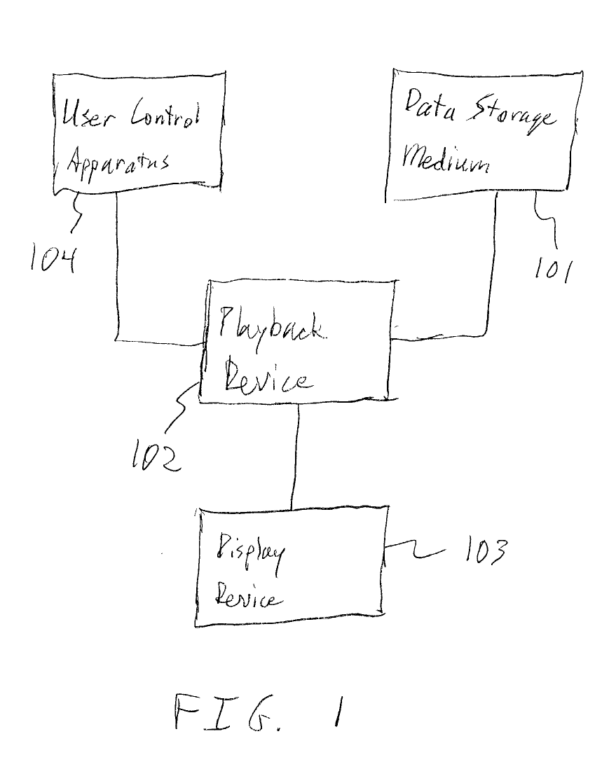

FIG. 1 is a block diagram illustrating components of a system in which the invention can be used. The components of the system illustrated in FIG. 1 can be embodied by any appropriate apparatus, as will be understood by those skilled in the art in view of the description herein. Content data is stored on data storage medium 101. The content data can include visual image data and/or audio content data. Metadata can also be stored on the data storage medium 101. The data storage medium 101 can be embodied by any data storage apparatus. For example, the data storage medium 101 can be embodied by a portable data storage medium or media, such as one or more DVDs, one or more CDs, or one or more videotapes. The data storage medium 101 can also be embodied by data storage apparatus that are not portable (in addition to, or instead of, portable data storage medium or media), such as a hard drive (hard disk) or digital memory, which can be part of, for example, a desktop computer or personal video recorder (PVR). Further, the content data can be stored on the data storage medium 101 in any manner (e.g., in any format). A playback device 102 causes content data (some or all of which, as indicated above, can be stored on the data storage medium 101) to be used to produce an audiovisual display on a display device 103. When some or all of the content data is stored on a portable data storage medium or media, the playback device 102 is constructed so that a portable data storage medium can be inserted into the playback device 102. The playback device 102 can be embodied by, for example, a conventional DVD player, CD player, combination DVD/CD player, or computer including a CD and/or DVD drive. The display device 103 can be embodied by, for example, a television or a computer display monitor or screen. A user control apparatus 104 is used to control operation of the playback device 102 and visual display device 103. The user control apparatus 104 can be embodied by, for example, a remote control device (e.g., a conventional remote control device used to control a DVD player, CD player or combination DVD/CD player), control buttons on the playback device 102 and/or visual display device 103, or a mouse (or other pointing device). As described in more detail elsewhere herein, the user control apparatus 104 and/or the playback device 102 (or processing device(s) associated therewith) can also be used to cause a slideshow according to the invention to be created. A slideshow creation system according to the invention can be implemented using the data processing, data storage and user interface capabilities of the components of the system of FIG. 1, as can be appreciated in view of the description herein.

The invention can advantageously be used, for example, with a home theater system. A home theater system typically includes a television and a digital video playback device, such as a DVD player or a digital PVR. A PVR (such as a Tivo™ or Replay™ device) typically contains a hard drive, video inputs and video encoding capabilities. The digital video playback device can be enhanced with software that reads metadata encoded on a digital data storage medium, which can be useful with some embodiments of the invention, as discussed elsewhere herein. The digital video playback device (or other apparatus of the home theater system) can also contain a network connection to the Internet or a local area network (LAN).

Although the invention can advantageously be used with a home theater system, the invention is not limited to use with that platform. A slideshow according to the invention can be created and displayed on any hardware platform that contains the appropriate devices. For example, the invention can be used with a personal computer, which often includes a video input (e.g., direct video input or a DVD drive), as well as a processor, a hard drive and a display device.

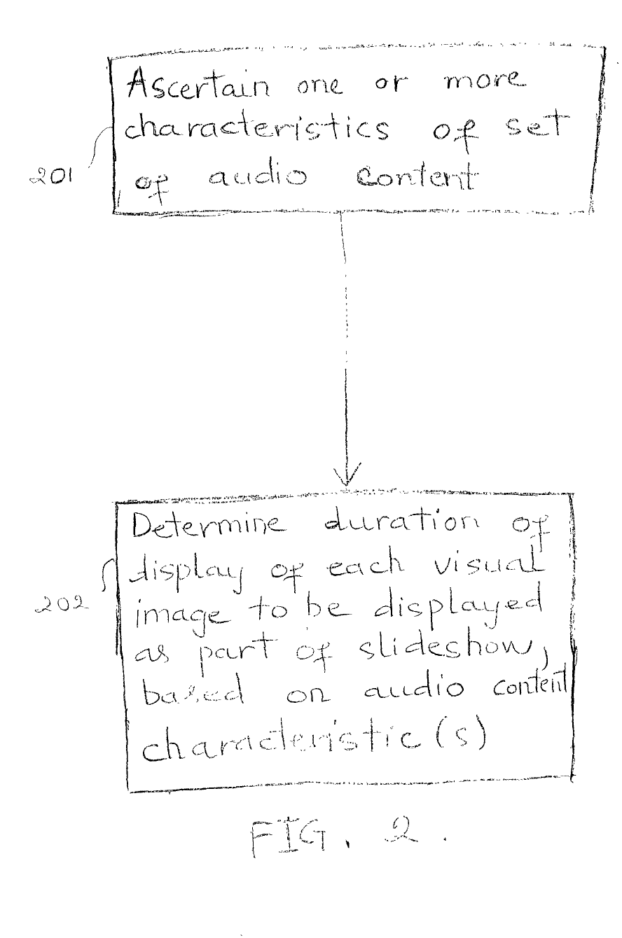

FIG. 2 is a flow chart of a method 200, according to an embodiment of the invention, for creating a slideshow that is to be accompanied by display of a set of audio content. In step 201, one or more characteristics of the set of audio content are ascertained (e.g., the occurrence of beats in music). The audio content characteristic(s) may already have been determined prior to the method 200. In that case, the predetermined audio content characteristic(s) are ascertained in any appropriate manner, such as by accessing stored data representing the audio content characteristic(s). The audio content characteristic(s) can also be determined as part of the step 201. Ways in which the audio content characteristic(s) can be determined (e.g., ways of determining the occurrence of beats in music) are described in more detail below. In step 202, the duration of the display of each of the visual images (slideshow images) to be displayed as part of the slideshow is determined, the determination of the duration of the display of the slideshow images being based on the audio content characteristic(s) ascertained in the step 201. The manner of determination of the duration of the display of the slideshow images can depend on the type of audio content characteristic(s) ascertained in step 201 (e.g., the method used for determining slideshow image display durations based on the occurrence of beats in music can be different from that used for determining slideshow image display durations based on the occurrence of pauses in a narrative). Ways in which the duration of the display of the slideshow images can be determined based on audio content characteristic(s) are described in more detail below. The method 200 can be used, for example, to create a slideshow in which all visual images of a collection of visual images are displayed as part of the slideshow, the audio content being displayed (repetitively, if necessary) until all of the visual images have been displayed. The method 200 can also be used, for example, to create a slideshow in which visual images of a collection of visual images are “mechanically” displayed (repetitively, if necessary) in the order in which the visual images exist in the collection for the duration of the display of the audio content one or more times.

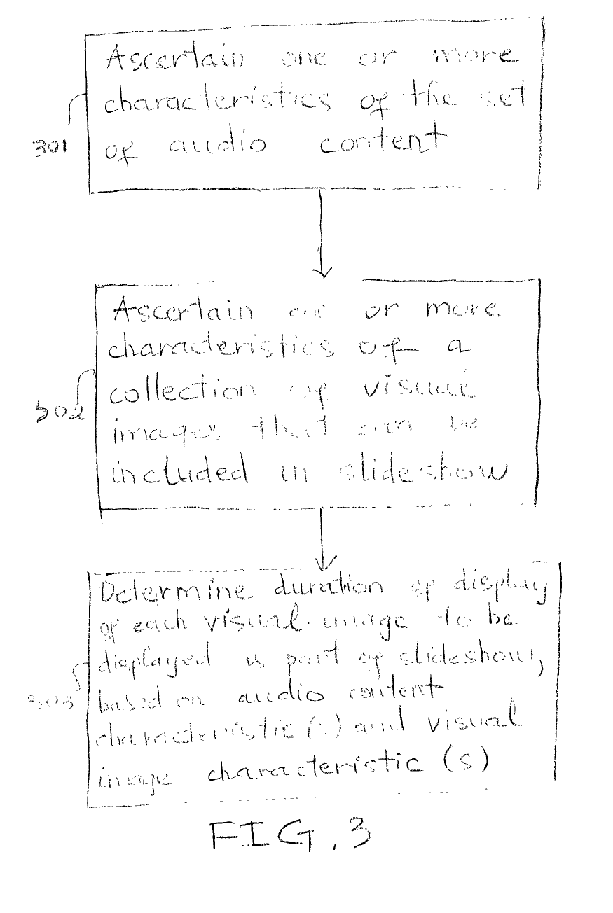

FIG. 3 is a flow chart of a method 300, according to another embodiment of the invention, for creating a slideshow that is to be accompanied by display of a set of audio content. In step 301, one or more characteristics of the set of audio content are ascertained. The step 301 can be implemented as described above with respect to the step 201 of the method 200 of FIG. 2 and elsewhere herein. In step 302, one or more characteristics of a collection of visual images that can be included in the slideshow are ascertained (e.g., the subject matter of the collection of visual images). The visual image characteristic(s) may already have been determined prior to the method 300. In that case, the predetermined visual image characteristic(s) are ascertained in any appropriate manner, such as by accessing stored data representing the visual image characteristic(s). The visual image characteristic(s) can also be determined as part of the step 302. In step 303, the duration of the display of each of the visual images (slideshow images) to be displayed as part of the slideshow is determined, the determination of the duration of the display of the slideshow images being based on the audio content characteristic(s) ascertained in the step 301 and on the visual image characteristic(s) ascertained in the step 302. Ways in which visual image characteristic(s) can be determined for use in determining the duration of the display of slideshow images, as well as ways of determining the duration of the display of slideshow images based on audio content characteristic(s) and visual image characteristic(s) are described in more detail below. The method 300 can be used, for example, to create a slideshow of either of the types discussed above with respect to the method 200.

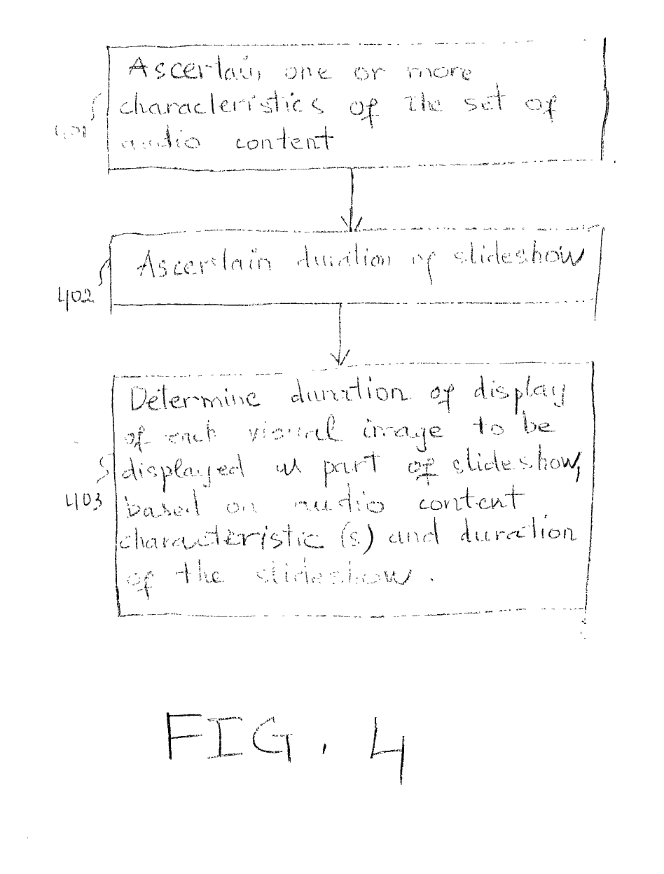

FIG. 4 is a flow chart of a method 400, according to yet another embodiment of the invention, for creating a slideshow that is to be accompanied by display of a set of audio content. In step 401, one or more characteristics of the set of audio content are ascertained. The step 401 can be implemented as described above with respect to the step 201 of the method 200 of FIG. 2 and elsewhere herein. In step 402, the duration of the slideshow is ascertained. The duration of the slideshow can be established prior to the method 400 or at the time of operation of the method 400 (i.e., as part of the step 401). Ways in which the duration of the slideshow can be established and ascertained are described in more detail below. In step 403, the duration of the display of each of the visual images (slideshow images) to be displayed as part of the slideshow is determined. The determination of the duration of the display of the slideshow images can be based on the audio content characteristic(s) ascertained in the step 401. In that case, the step 403 can be implemented as described above with respect to the step 202 of the method 200 of FIG. 2 and elsewhere herein. The determination of the duration of the display of the slideshow images can additionally be based on the duration of the slideshow ascertained in the step 402. For example, if as the duration of the slideshow increases, the duration of the display of the slideshow images can be increased. Alternatively or additionally, the duration of the slideshow can be used to select slideshow images from a collection of visual images that can be included in the slideshow. The method 400 can be used, for example, to create a slideshow in which all visual images of a collection of visual images are displayed as part of the slideshow, the duration of display of the slideshow images being established, in view of the known duration of the slideshow, to ensure that all of the visual images are displayed during the slideshow. The method 400 can also be used, for example, to create a slideshow in which visual images of a collection of visual images are “mechanically” displayed (repetitively, if necessary) in the order in which the visual images exist in the collection for the duration of the slideshow.

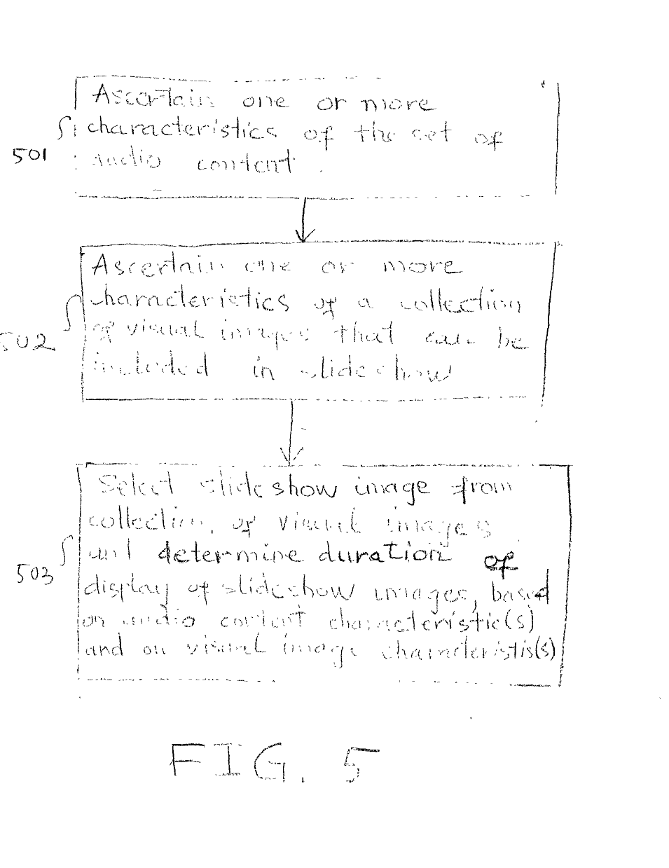

FIG. 5 is a flow chart of a method 500, according to still another embodiment of the invention, for creating a slideshow that is to be accompanied by display of a set of audio content. In step 501, one or more characteristics of the set of audio content are ascertained. The step 501 can be implemented as described above with respect to the step 201 of the method 200 of FIG. 2 and elsewhere herein. In step 502, one or more characteristics of a collection of visual images that can be included in the slideshow are ascertained (e.g., the subject matter of the collection of visual images, the quality of visual images in the collection of visual images, identification of keyframes in the collection of visual images). The visual image characteristic(s) may already have been determined prior to the method 500. In that case, the predetermined visual image characteristic(s) are ascertained in any appropriate manner, such as by accessing stored data representing the visual image characteristic(s). The visual image characteristic(s) can also be determined as part of the step 502. Ways in which the visual image characteristic(s) can be determined (e.g., ways of determining the quality of a visual image or of identifying a keyframe in a collection of visual images are described in more detail below. In step 503, visual images (slideshow images) are selected from the collection of visual images for inclusion in the slideshow and the duration of the display of the slideshow images is determined, the selection of slideshow images and determination of the duration of the display of slideshow images being based on the audio content characteristic(s) ascertained in the step 501 and on the visual image characteristic(s) ascertained in the step 502. Ways in which audio content characteristic(s) and visual image characteristic(s) can be used to select slideshow images and determine the duration of the display of slideshow images are described in more detail below. The method 500 can be used, for example, to create a slideshow in which a subset of a collection of visual images are selected and displayed for the duration of the display of a set of audio content one or more times.

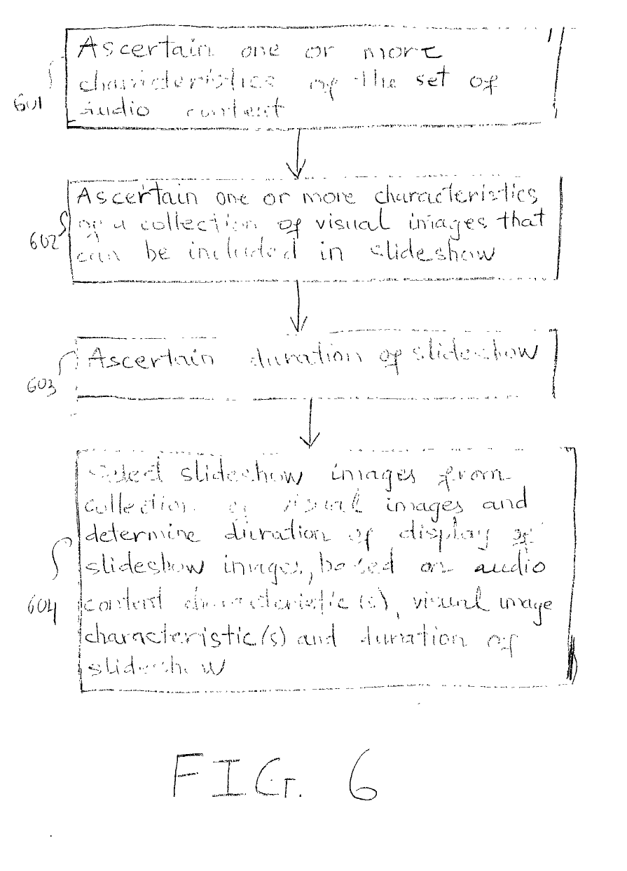

FIG. 6 is a flow chart of a method 600, according to another embodiment of the invention, for creating a slideshow that is to be accompanied by display of a set of audio content. In step 601, one or more characteristics of the set of audio content are ascertained. The step 601 can be implemented as described above with respect to the step 201 of the method 200 of FIG. 2 and elsewhere herein. In step 602, one or more characteristics of a collection of visual images that can be included in the slideshow are ascertained. The step 602 can be implemented as described above with respect to the step 502 of the method 500 of FIG. 5 and elsewhere herein. In step 603, the duration of the slideshow is ascertained. The step 603 can be implemented as described above with respect to the step 402 of the method 400 of FIG. 4 and elsewhere herein. In step 604, visual images (slideshow images) are selected from the collection of visual images for inclusion in the slideshow and the duration of the display of the slideshow images is determined, the selection of slideshow images and determination of the duration of the display of slideshow images being based on the audio content characteristic(s) ascertained in the step 601, the visual image characteristic(s) ascertained in the step 602 and the duration of the slideshow ascertained in the step 603. Ways in which audio content characteristic(s), visual image characteristic(s) and the duration of a slideshow can be used to select slideshow images and determine the duration of the display of slideshow images are described in more detail below. The method 600 can be used, for example, to create a slideshow of the type discussed above with respect to the method 500.

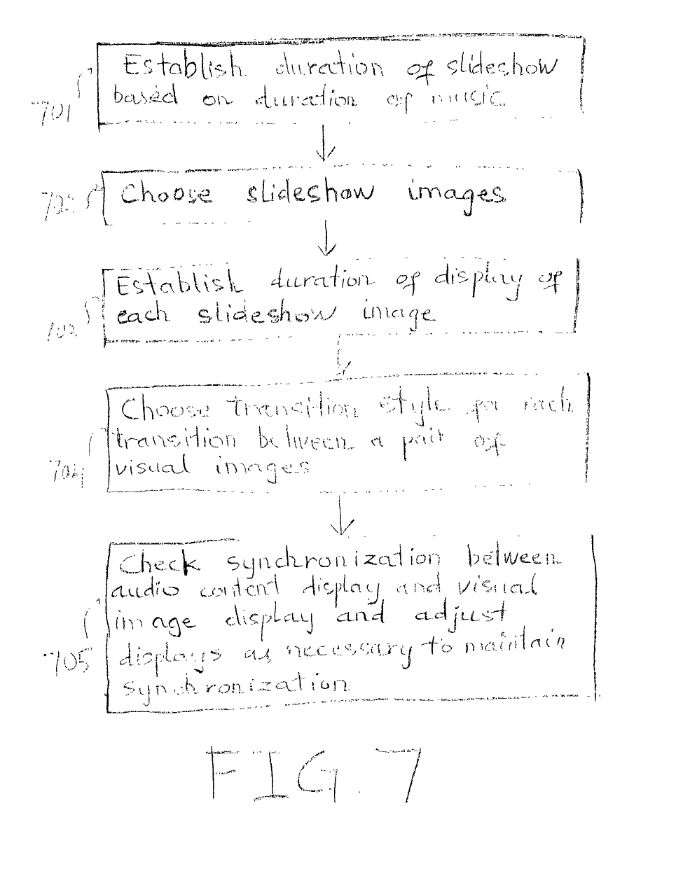

Each of the methods according to the invention described above with respect to FIGS. 2 through 6 determine the duration of the display of the slideshow images and some of those methods select visual images from a collection of visual images for inclusion in the slideshow. Each of the methods of FIGS. 2 through 6 can further include a step of displaying the slideshow images for the determined duration. Further, as discussed above, some methods according to the invention can be implemented to display the slideshow images in an order that is different from that in which the slideshow images are arranged in the collection of visual images prior to use in the slideshow. Additionally, in some embodiments of the invention, visual images are selected for inclusion in a slideshow based on an ordering of the visual images of a collection of visual images (e.g., visual images are selected in order of image importance, as discussed below with respect to FIG. 7). Such embodiments can be implemented to display the slideshow images in the order in which the images were selected or a different order (e.g., visual images can be selected in order of image importance, but displayed in chronological order, which will typically be different from the order in which the visual images were selected).

The invention can be implemented so that, from a user's perspective, generating a slideshow using the invention is extremely straightforward. (Herein, “user” refers to a person that desires to create a slideshow according to the invention.) This is an important advantage of the invention which is made possible through the use of metadata (as described in more detail elsewhere herein) and by implementing the invention so that at least some (and, often, many or all) aspects of creating a slideshow are performed automatically without user intervention. In particular, the invention can be implemented so that a user need only take minimal action to cause a slideshow to be generated. The user must take action to indicate the user's desire to create a slideshow. Further, it is anticipated that the invention will usually be implemented so that the user must take action to indicate the collection of visual images to be used to create the slideshow. The invention can also be implemented so that the user can or must take action to indicate the audio content to be used in creating the slideshow and displayed with the slideshow. However, the invention can be implemented so that each of requesting creation of a slideshow, selecting a visual image collection and selecting audio content can be done either explicitly or implicitly as a result of user action. For example, a slideshow creation system according to the invention can be implemented so that insertion into a data reading device of the system of a data storage medium on which is stored content data and/or metadata representing a collection of visual images and/or audio content automatically causes a slideshow creation method according to the invention to operate to create a slideshow (i.e., requesting creation of a slideshow occurs implicitly as a result of user action). Similarly, a slideshow creation system according to the invention can be implemented so that such user action constitutes an implicit instruction to use visual image data and/or audio data stored on the data storage medium to create a slideshow. Alternatively, a slideshow creation system according to the invention can be implemented so that operation of a slideshow creation method according to the invention occurs only upon provision of an instruction by the user to the system using a user interface mechanism or mechanisms (e.g., a conventional remote control device and/or conventional graphical user interface techniques) constructed to enable the user to explicitly request creation of a slideshow. Similarly, a slideshow creation system according to the invention can be implemented so that a user interface mechanism (e.g., a conventional remote control device and/or conventional graphical user interface techniques) must be used to explicitly identify the collection of visual images and/or the audio content to be used in creation of a slideshow.

For example, in one embodiment, the invention is implemented so that a user need only make two choices, both of which can be made using a standard remote control, to effect creation of a slideshow. To enable creation of a slideshow, the user inserts into an appropriate playback device of an audiovisual display system (such as a conventional DVD player, CD player, combination DVD/CD player, or CD or DVD drive of a computer) a portable data storage medium (such as a DVD or CD) on which is stored content data and associated metadata. The audiovisual display system can be implemented so that when the portable data storage medium is inserted into the playback device, the existence of the metadata stored on the portable data storage medium is detected, which causes display of a user interface mechanism that indicates various operations that can be performed on the content data using the metadata, including creation of a slideshow in accordance with the invention (e.g., a display menu including a menu option denoted by “Display Slideshow” or similar text). Appropriate input to the user interface mechanism (e.g., selection of the Display Slideshow menu option) by the user causes display of a new menu including a list of audio content choices (e.g., a menu of music choices). Selection of particular audio content by the user automatically causes creation of the slideshow to begin, i.e., the steps of a method according to the invention for selecting slideshow images (if applicable) and determining the duration of display of slideshow images are automatically performed (see, e.g., FIGS. 2 through 6 and associated description). The invention can be further implemented so that if the user does nothing after insertion of the portable data storage medium into the playback device, after a predetermined wait period, the system automatically makes one or more default choices to enable creation of a slideshow (e.g., a default audio content selection), then creates the slideshow (and, if the system is so implemented, displays the slideshow).

As discussed above, the invention makes use of two types of data to enable creation of a slideshow: content data (e.g., visual recording data, still visual image data, audio data) and metadata (i.e., data representing information about the content data). As discussed further below, the content data can take a variety of forms and be provided for use by a slideshow creation system according to the invention in a variety of ways. The invention creates a slideshow using digital content data, which can be obtained directly using a digital data acquisition device (e.g., digital still or video camera) or produced by converting analog content data obtained using an analog data acquisition device (e.g., analog still or video camera) to digital content data using techniques known to those skilled in the art. The metadata can be provided to a slideshow creation system according to the invention (having been produced before operation of that system to create a slideshow) or the metadata can be produced by a slideshow creation system according to the invention.

The invention can be used to create a slideshow from any collection of visual images. For example, the invention can be used to create a slideshow using visual images from a visual recording, such as a videotape. Or, for example, the invention can be used to create a slideshow from a collection of still visual images, such as a collection of digital photographs. A collection of visual images from which the invention can be used to create a slideshow can also include both visual images from a visual recording and still visual images. A collection of visual images from which the invention can be used to create a slideshow can also include visual images such as Powerpoint slides or animated drawings. In the latter case, for example, a series of visual images selected for a slideshow can be a series of animated drawings that, when viewed at an appropriate rate, can produce a short segment of animation. Those skilled in the art will readily appreciate that there are other types of collections of visual images with which the invention can be used.

As discussed above, the invention creates a slideshow using digital content data. Digital visual image data can be obtained in a variety of ways. For example, a user can acquire a visual recording directly in digital form by, for example, recording on to miniDV tape, optical disk or hard drive. Or, for example, a user can digitize analog visual image content and store the digitized visual image content on one or more digital data storage media such as DVD(s), CD-ROM(s) or a hard drive. A user can do this using existing software program(s) on a conventional computer. There also exist cost-effective services for digitizing analog visual image data, as provided, for example, by YesVideo, Inc. of San Jose, Calif.

During or after acquisition or digitization of the visual image data, metadata can be produced regarding the visual image data. The metadata can be stored on a portable data storage medium or media (e.g., one or more DVDs or CDs) together with visual image data. The metadata can be stored in a standard data format (e.g., in one or more XML files). As indicated above, visual image metadata can be created manually (e.g., by being specified by a creator of visual image data or by a user or operator performing processing, such as digitization, of the visual image data) or automatically (e.g., by performing computer analysis of visual image data). Visual image metadata that is typically created manually can include, for example, data representing a title for, a description of, and the name of a creator (e.g., a person or entity who acquired, or caused to be acquired, content data) of a visual image or a collection of visual images. Visual image metadata that is typically created automatically (but can also be created manually) can include, for example, data representing the number of visual images, the locations of visual images within a visual recording (if appropriate), the date of acquisition (capture) of the visual images, the date of digitization of the visual images, the quality of visual images, and image importance values for the visual images, and data identifying the location of scene breaks and/or keyframes in a visual recording. In one embodiment of the invention, visual image metadata is stored in XML format on a DVD or CD together with a visual recording during the capture or digitization process and includes at least data representing the title, description and date of capture of the visual recording, and frame indices corresponding to the visual images of the visual recording determined to have the highest quality.

The quality of a visual image can be determined using any of a variety of methods. For example, visual image quality can be determined using a method as described in commonly-owned U.S. Provisional Patent Application Serial No. 60/306,282, entitled “Autosnap: A Method for Automatically Selecting Still Frames from Video,” filed on Jul. 17, 2001, by Michele Covell et al., or as described in commonly-owned, co-pending U.S. patent application Ser. No. 10/198,602, entitled “Automatic Selection of a Visual Image or Images from a Collection of Visual Images, Based on an Evaluation of the Quality of the Visual Images,” filed on Jul. 17, 2002, by Michele Covell et al., the disclosures of which are hereby incorporated by reference herein.

The location of scene breaks and/or keyframes in a visual recording can be identified using any of a variety of methods. For example, a keyframe can be identified as the first (i.e., temporally earliest) frame of a segment of a visual recording. (Segments can be identified, for example, as scenes, i.e., the visual recording content between scene breaks.) A keyframe can also be identified by evaluating the content of a segment of a visual recording and choosing as the keyframe a frame of the segment that is determined to be, based on the evaluation, representative of the content of the segment. For example, keyframes (and scene breaks) can be identified using a method as described in commonly-owned, co-pending U.S. patent application Ser. No. 09/792,280, entitled “Video Processing System Including Advanced Scene Break Detection Methods for Fades, Dissolves and Flashes,” filed on Feb. 23, 2001, by Michele Covell et al., the disclosure of which is hereby incorporated by reference herein. Keyframes can also be identified using a method as described in the above-referenced U.S. Provisional Patent Application Serial No. 60/306,282 or in the above-referenced U.S. patent application Ser. No. 10/198,602.

When the invention is used to create a slideshow from a visual recording, typically a subset of still visual images is selected from the visual recording for inclusion in the slideshow. These slideshow images can be extracted from the visual recording and stored together with the visual recording (in any standard visual image format, such as JPEG, BMP, or GIF), or indices to the slideshow images can be stored with the visual recording to enable the corresponding visual images to be extracted from the visual recording at the time of displaying the slideshow. The invention can be implemented so that multiple resolutions of each visual image in a collection of visual images are stored, e.g., a low resolution version for displaying the visual images as thumbnails, a medium resolution version for displaying the visual images on a television screen, and a high resolution version for printing the visual images.

Any type of audio content can be used to create the slideshow and accompany the slideshow display. It is anticipated that the audio content will often be music. However, the audio content could also be, for example, a narrative.

The audio content metadata is determined by evaluating the audio content data. When the audio content includes music (entirely or in part), the music can be evaluated to identify beats in the music. (The display of visual images in the slideshow can be controlled in accordance with the occurrence of beats in music, as described in more detail below.) The identification of beats in music can be accomplished in a variety of ways, as known to those skilled in the art. Qualitatively, beats are identified as how a person would “tap to” the music. The identification of beats can be done manually, by a person listening to the music and tapping out the beats. The identification of beats can also be done automatically by one or more computer programs that analyze the music and identify beats. This can be done, for example, using a method as described in “Tempo and beat analysis of acoustic musical signals, by Eric D. Scheirer, J. Acoust. Soc. Am. 103(1), January 1998, the disclosure of which is incorporated by reference herein. Each beat can be represented as a temporal offset, T_{b}, from the beginning of the music. The spacing between beats can be constant or variable: while much music has a constant beat, some music (e.g., syncopated music) has variable beat spacing.

Some music has no beat and can therefore not be evaluated to identify that type of audio content metadata (i.e., beats) for use in creating a slideshow according to the invention. When the audio content includes music having no beat, other types of audio content metadata can be determined. For example, audio volume during the audio content display can be automatically determined and used to determine the duration of each slideshow image (i.e., when to transition from one slideshow image to a next). Or, in some embodiments of the invention (i.e., when another aspect of the invention is performed automatically), the duration of each slideshow image can be determined manually, either based on one or more characteristics of the audio (audio content metadata) or not, rather than automatically based on audio content characteristic(s).

Other types of audio content data can be evaluated to determine other types of audio content metadata. For example, when the audio content includes a narrative (entirely or in part), the narrative can be evaluated to identify pauses in the narration. Pauses can be identified using methods for pause recognition, as known to those skilled in the art. For example, as known to those skilled in the art of speech recognition, a pause can be identified as an audio segment in which no speech is detected. The narrative can also be evaluated to identify a change in subject matter of the narrative. Subject matter changes in speech can be identified using methods known to those skilled in the art. (The display of visual images in the slideshow can be controlled in accordance with the occurrence of pauses and/or subject matter changes in the narration, in a manner similar to that described in more detail below for controlling the display of visual images in accordance with the occurrence of beats in music.)

The audio content data and associated metadata can be provided in a variety of different ways for use by a slideshow creation system according to the invention (which can, for example, be part of a broader system, such as a home theater system or other audiovisual display system). The invention can be implemented so that the audio content data, the audio content metadata or both are stored on a portable data storage medium or media (which can also store the visual image data and/or visual image metadata), such as one or more DVDs or CDs, which can be inserted into an appropriate data reading device to enable access to the audio content data and/or metadata by the slideshow creation system or a system of which the slideshow creation system is part. The invention can also be implemented so that the slideshow creation system or a system of which the slideshow creation system is part enables connection to a network, such as the Internet or a local area network (LAN), to enable acquisition of the audio content data, the audio content metadata or both from another site on the network at which that data is stored. The invention can also be implemented so that the audio content data, the audio content metadata or both are stored on a data storage medium or media (e.g., hard drive) included as part of the slideshow creation system or a system of which the slideshow creation system is part. The audio content data and audio content metadata can be provided to the slideshow creation system together or separately. Additionally, the invention can be implemented so that only the audio content data is provided to the slideshow creation system, which then evaluates the audio content data to produce the audio content metadata. Some examples of how audio content data and associated metadata can be provided for use by a slideshow creation system according to the invention are described below.

For example, the audio content data and associated metadata can be stored on a portable data storage medium or media (e.g., one or more DVDs or CDs) together with the visual image data. A user can cause the audio content data and associated metadata to be stored on DVD(s) or CD(s) when using software program(s) and a DVD or CD burner to create the DVD(s) or CD(s). Or, when a commercial service (such as that provided by YesVideo, Inc. of San Jose, Calif.) digitizes analog visual image data and stores the digital visual image data on a DVD or CD, a user can request that audio content (e.g., music) be stored on the DVD or CD together with the digital visual image data.

A slideshow creation system or a system (e.g., home theater system) of which the slideshow creation system is part can include a hard drive and an audio CD reader (most DVD players, for example, can also read audio CDs). The system can also include software for creating audio content metadata. In such case, the audio content data can be stored on a CD (or other portable data storage medium from which data can be accessed by the system). The user inserts the audio CD into the audio CD reader and the audio content data is transferred to the hard drive, either automatically or in response to a user instruction. As or after the audio content data is transferred to the hard drive, the metadata creation software evaluates the audio content data and produces the audio content metadata. The system can also be implemented to enable (and prompt for) user input of some metadata (e.g., titles for musical content, such as album and song titles).

Many music CDs contain information that uniquely identifies the album and each song. The acquisition of audio content data and associated metadata described above can be modified to enable acquisition of metadata via network over which the system can communicate with other network sites. The metadata for popular albums and songs can be pre-generated and stored at a known site on the network. The system can use the identifying information for musical content on a CD to acquire associated metadata stored at the network site at which audio content metadata is stored.

When the slideshow is created by selecting visual images from a collection of visual images, the visual image metadata can be used to select, or prioritize for selection, visual images from the collection. For example, each of the visual images of a collection of visual images can be evaluated to determine an “image importance” for the visual image (which can be represented as a score for the visual image), and visual images selected for inclusion in the slideshow, or prioritized for selection, based on relative image importances. Image importance can be determined in any appropriate manner. For example, image importance can be determined based on an evaluation of the quality of the visual image (i.e., a measurement of image characteristics such as sharpness and/or brightness). Image quality can be determined, for example, as described in the above referenced U.S. Provisional Patent Application Serial No. 60/306,282 or in the above-referenced U.S. patent application Ser. No. 10/198,602. Image importance can also be determined based on an evaluation of the content of the visual image. Image content can be evaluated by, for example, evaluating the likelihood that a visual image is a keyframe (e.g., giving preference—increasing the image importance score—to the first visual image of each scene of a visual recording), as described in the above-referenced U.S. patent application Ser. No. 09/792,280. Image importance can also be determined as a combination of image quality and image content. For example, an image importance score determined by evaluating image quality can be raised or lowered based on whether or not a visual image is a keyframe, or a likelihood that a visual image is a keyframe (raised if a visual image is, or is likely to be, a keyframe). Once the visual images have been evaluated, the visual images can be selected, or prioritized for selection, using any desired method. For example, visual images having an image importance score greater than a specified threshold can be selected for inclusion in the slideshow. Or, visual images can be prioritized for selection by selecting visual images for inclusion in the slideshow beginning with the visual image having the highest image importance score and continuing in succession with visual images having the next highest image importance score until visual images have been selected to fill the entire slideshow (the duration of the slideshow having previously been determined). As indicated by the foregoing, when the visual image metadata is used to prioritize the visual images for selection, the number of visual images actually selected can depend on the duration of display of each selected visual image (determined as discussed below) and the duration of the slideshow (determined as discussed below).

Audio content metadata can be used to establish the duration of display of each visual image in the slideshow. In particular, the audio content metadata can be used to determine particular points in the audio content at which it is acceptable and/or desirable to transition from one visual image to another. For example, when the audio content includes music, the duration of display of each visual image can be chosen based on the tempo of the music, i.e., in accordance with the occurrence of beats in the music. The transition point (Which can be specified, for example, as a temporal offset from the beginning of the audio content or from the most recent beat) from one image to the next depends on the number of images displayed per beat, N_{b}, and an offset, T_{┐}, from the location, T_{b}, of the most recent beat b. T_{┐}, can be negative, zero, or positive: when T_{┐}=0, the visual image transition coincides exactly with a beat; when T_{┐}<0, the visual image transition occurs prior to the beat by an amount equal to T_{┐}; and when T_{┐}>0, the visual image transition occurs after the beat by an amount equal to T_{┐}. T_{┐} can be constant throughout a slideshow, but need not be; in fact, T_{┐} can be varied randomly from one visual image to the next. The number of images per beat, N_{b}, is always a positive number less than a maximum number of images per beat, N: 0<N_{b}<N. N is equal to the maximum visual image display rate of the visual display device divided by the beat timing (e.g., number of beats per second) in the music. When N_{b}=1, there is exactly one visual image per beat. N_{b}<1 indicates multiple beats per image, while N_{b}>1 indicates multiple images per beat. For example, in a song with 4/4 timing, N_{b}=0.25 cause visual image transitions to occur at each measure. Making N_{b} greater than 1 produces a faster paced slideshow. Like the offset, T_{┐}, N_{b} can be constant throughout a slideshow or can vary within a slideshow (including variation from visual image to visual image).

The duration of a slideshow can be established in any appropriate manner. For example, a user can specify a desired slideshow duration directly. The slideshow duration can also be related to the duration of the display of the audio content, e.g., the slideshow duration can be some multiple of the duration of a single audio content display. It is anticipated that the slideshow duration will often be established as the duration of a single display of the audio content.

The invention can be implemented to produce a particular type of transition between the display of one visual image and the display of the next visual image. For example, the transition between visual images can be a sharp cut. Or, for example, the transition between visual images can be a slow dissolve. The type of transition can be chosen to create a particular mood. For example, when the slideshow is accompanied by music, the invention can be implemented so that a sharp cut transition is used when the beat frequency is above a specified threshold value, and a slow dissolve is used when the beat frequency is below a specified threshold value (the threshold values can be the same). The invention can be implemented so that visual image display transition styles can be mixed during a slideshow.

During the slideshow, for any of a variety of reasons, the audio display and visual image display can become unsynchronized. The invention can be implemented so that, during the display of the slideshow, the synchronization between the audio display and visual image display is periodically checked and the displays adjusted as necessary to maintain synchronization. The invention can be implemented so that the audio display takes priority: the timings of the visual image displays are synchronized to the timing of the audio content display. Synchronization between the audio display and visual image display can be monitored and adjusted using techniques known to those skilled in the art.

FIG. 7 is a flow chart of a method 700, according to another embodiment of the invention, for creating a slideshow that is to be accompanied by display of a set of audio content. The method 700 is used to select visual images from a collection of visual images (e.g., a visual recording) for a slideshow that will be accompanied by music. However, the method 700 can be modified to create a slideshow accompanied by other types of audio content, as can readily be understood in view of the description elsewhere herein.

In step 701, the duration of the slideshow is chosen based on the duration of the music. As discussed above, the duration of the slideshow can be made equal to the duration of a single display of the music or the duration of the slideshow can be made equal to a specified number of displays of the music. A slideshow of arbitrary length can be produced, depending on the number of times that the music display is looped.

In step 702, visual images are chosen from the collection of visual images for inclusion in the slideshow. The exact number of visual images chosen depends on the duration of display of each selected visual image (determined in step 703, discussed below) and the duration of the slideshow (determined in step 701, discussed above). In one implementation of the method 700, visual images are chosen from the collection of visual images, in the order that the visual images exist in the collection (e.g., chronological order), until visual images have been selected to fill the entire slideshow. In another implementation of the method 700, visual images are included in the slideshow based on an evaluation of one or more characteristics of the collection of visual images. For example, each of the visual images of the collection can be evaluated to determine an “image importance” for the visual image (image importance can be determined in any appropriate manner, as discussed in detail above) and visual images selected for inclusion in the slideshow based on relative image importances (i.e., in order of image importance, beginning with the visual image having the highest image importance). The visual images selected for inclusion in the slideshow can be displayed in any order. If the music display is looped, visual images can be selected for a single display of the music and looped with the music, or new visual images can be selected for successive music displays (for example, by continuing the selection of the visual images in the same manner as used to select visual images for the first music display).

In step 703, the duration of display of each slideshow image is established. This can be done using audio content metadata. For example, slideshow image display duration can be based on the occurrence of beats in the music. The slideshow image display durations can be based on any desired number of images displayed per beat, N_{b} (which be constant or can vary during the slideshow), and any desired offset, T_{┐} (which can also be constant or can vary during the slideshow), in accordance with the detailed discussion above of determining slideshow image display durations based on the occurrence of beats in music.

In step 704, a transition style is chosen for each transition between a pair of visual images. In one implementation of the method 700, one of two transition styles can be chosen: a sharp cut or a slow dissolve. In a particular implementation of the method 700, a sharp cut transition is chosen when the beat frequency is above a specified threshold value and a slow dissolve is chosen when the beat frequency is below the specified threshold value.

In step 705, the synchronization between the audio content display and visual image display is checked and the displays are adjusted as necessary to maintain synchronization. The step 705 can be implemented so that the visual image display is synchronized to the audio content display.

The invention can be implemented so that the slideshow image display durations are determined dynamically by looking ahead. Further, the invention can be implemented so that a user can adjust slideshow parameters (e.g., slideshow duration, slideshow image display duration) during display of the slideshow.

In some embodiments of the invention, one or more visual images in a collection of visual images may be selected for display multiple times in a single slideshow or in multiple slideshows that are produced from the same collection of visual images (e.g., two slideshows accompanied by different musical content that are to be produced from the same visual recording). In that case, the invention can be implemented so as to minimize repetitious display of visual images and to maximize the duration of time between successive displays of the same visual image. This can be done, for example, by implementing the invention so that a visual image is selected for repeat display only when all other visual images that can be selected for display have already been displayed, and the duration of time between the repeat displays for that visual image is greater than the duration of time between repeat displays for any other visual image that can be selected (this can be determined by storing a time stamp that identifies when each visual image was last displayed). Additionally, when multiple slideshows are being produced from the same collection of visual images, the invention can be implemented so that if one or more visual images must be used in both slideshows, redundant images selected for a slideshow are those that are determined to be most visually distinct from visual images already displayed in that slideshow. Visual distinctness can be determined using techniques (e.g., color histograms, image differences) described in the above-referenced U.S. Provisional Patent Application Serial No. 60/306,282 or in the above-referenced U.S. patent application Ser. No. 10/198,602.

The invention can be implemented so that one or more slideshows can be created prior to the time at which the slideshows are to be displayed. The user can be presented with choices regarding various parameters of the slideshow, such as, for example, the duration of the slideshow, the duration of display of each slideshow image, the display sequence of the slideshow images and the transition style(s).

The invention can be implemented, for example, by one or more computer programs and/or data structures including instruction(s) and/or data for accomplishing the functions of the invention. For example, such computer program(s) and/or data structures can include instruction(s) and/or data for digitizing content data, evaluating content data to produce metadata, determining the duration of a slideshow, selecting (or prioritizing for selection) visual images for inclusion in a slideshow, determining the duration of display of a slideshow image, generating a slideshow display, producing a specified transition between visual image displays, and/or synchronizing the audio and visual displays of a slideshow. Those skilled in the art can readily implement the invention using one or more computer program(s) and/or data structures in view of the description herein.

Various embodiments of the invention have been described. The descriptions are intended to be illustrative, not limitative. Thus, it will be apparent to one skilled in the art that certain modifications may be made to the invention as described herein without departing from the scope of the claims set out below.

We claim:

1. A method for creating a slideshow that is to be accompanied by display of a set of audio content, comprising the steps of:
ascertaining one or more characteristics of the set of audio content; and
determining the duration of the display of each of a plurality of visual images to be displayed as part of the slideshow, based on the one or more characteristics of the set of audio content, wherein one of the steps of the method is performed automatically.

2. A method as in claim 1, wherein the step of ascertaining one or more characteristics of the set of audio content further comprises the step of evaluating the set of audio content to identify the one or more characteristics of the set of audio content.

3. A method as in claim 2, wherein:
the set of audio content comprises music; and
the step of evaluating the set of audio content comprises the step of identifying beats in the music.

4. A method as in claim 1, further comprising the step of ascertaining one or more characteristics of the plurality of visual images, wherein the determination of the duration of the display of each of the plurality of visual images is further based on one or more characteristics of the plurality of visual images.

5. A method as in claim 1, further comprising the step of selecting the plurality of visual images from a collection of visual images.

6. A method as in claim 5, further comprising the step of ascertaining one or more characteristics of the collection of visual images, wherein the step of selecting further comprises the step of selecting the plurality of visual images from the collection of visual images based on one or more characteristics of the collection of visual images.

7. A method as in claim 6, wherein the step of ascertaining one or more characteristics of the collection of visual images further comprises the step of evaluating the collection of visual images to identify the one or more characteristics of the collection of visual images.

8. A method as in claim 7, wherein the step of evaluating further comprises the step of evaluating the quality of each of the visual images in the collection of visual images.

9. A method as in claim 7, wherein the step of evaluating further comprises the step of identifying keyframes in the collection of visual images.

10. A method as in claim 6, further comprising the step of ascertaining the duration of the slideshow, wherein the step of selecting further comprises the step of selecting the plurality of visual images from the collection of visual images based on the duration of the slideshow.

11. A method as in claim 5, further comprising the step of ascertaining the duration of the slideshow, wherein the step of selecting further comprises the step of selecting the plurality of visual images from the collection of visual images based on the duration of the slideshow.

12. A method as in claim 11, wherein the duration of the slideshow is an integral multiple of the duration of a single display of the set of audio content.

13. A method as in claim 12, wherein the duration of the slideshow is equal to the duration of a single display of the set of audio content.

14. A method as in claim 5, wherein the collection of visual images comprises a collection of still images.

15. A method as in claim 5, wherein the collection of visual images comprises a visual recording.

16. A method as in claim 1, further comprising the step of ascertaining the duration of the slideshow, wherein the determination of the duration of the display of each of the plurality of visual images is further based on the duration of the slideshow.

17. A method as in claim 1, further comprising the step of specifying an order of display of the selected visual images.

18. A method as in claim 1, wherein the set of audio content comprises music.

19. An apparatus for creating a slideshow that is to be accompanied by display of a set of audio content, comprising:
means for ascertaining one or more characteristics of the set of audio content; and
means for determining the duration of the display of each of a plurality of visual images to be displayed as part of the slideshow, based on the one or more characteristics of the set of audio content.

20. A computer readable medium or media encoded with one or more computer programs and/or data structures for creating a slideshow that is to be accompanied by display of a set of audio content, comprising:
instructions and/or data for ascertaining one or more characteristics of the set of audio content; and
instructions and/or data for determining the duration of the display of each of a plurality of visual images to be displayed as part of the slideshow, based on the one or more characteristics of the set of audio content.

21. A method for creating a slideshow that is to be accompanied by display of a set of audio content, comprising the steps of:
identifying audio units in the set of audio content;
specifying a number of visual images to be displayed for each audio unit; and
identifying a visual image or images corresponding to each audio unit.

22. A method as in claim 21, wherein the set of audio content comprises music.

23. A method as in claim 22, wherein the step of identifying audio units comprises the step of identifying beats in the music.

24. A method as in claim 21, wherein the step of identifying audio units is performed manually.

25. A method as in claim 21, wherein the step of identifying audio units is performed automatically.

26. An apparatus for creating a slideshow that is to be accompanied by display of a set of audio content, comprising:
means for identifying audio units in the set of audio content;
means for specifying a number of visual images to be displayed for each audio unit; and
means for identifying a visual image or images corresponding to each audio unit.

27. A computer readable medium or media encoded with one or more computer programs and/or data structures for creating a slideshow that is to be accompanied by display of a set of audio content, comprising:
instructions and/or data for identifying audio units in the set of audio content;
instructions and/or data for specifying a number of visual images to be displayed for each audio unit; and
instructions and/or data for identifying a visual image or images corresponding to each audio unit.
